(19) United States
(12) Patent Application Publication
(10) Pub. No.: US 2010/0097712 A1
(43) Pub. Date: Apr. 22, 2010

(54) LENS DRIVING DEVICE COMPRISING A DRIVING COIL DISPOSED CLOSE TO EXPOSED LENSES

(75) Inventors: Nobuyuki MIURA, Tokyo (JP); Satoshi Ajiki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tokyo (JP)

(21) Appl. No.: 12/580,364

(22) Filed: Oct. 16, 2009

(30) Foreign Application Priority Data
Oct. 17, 2008 (JP) 2008-268230

(51) Int. Cl. G02B 7/02

(52) U.S. Cl. 359/824

(57) ABSTRACT

In a lens driving device including a movable portion including a lens barrel having a plurality of lenses and a driving coil, a fixed portion including a magnetic field generating portion including a permanent magnet opposite to the driving coil, and an elastic member mounted to the movable portion and the fixed portion and supporting the movable portion in a direction of an optical axis shiftably so as to position the movable portion in a radial direction, the plurality of lenses are connected with the plurality of lenses fixed to each other. The lens holder holds only an uppermost one among the plurality of lenses and remaining ones in the plurality of lenses except for the uppermost one are put into an exposed state. The driving coil is disposed close to outer edges of the exposed lenses.

This application is based upon and claims the benefit of priority from Japanese Patent Application JP 2008-268230, filed on Oct. 17, 2008, the disclosure of which is incorporated herein in its entirety by reference.

### BACKGROUND OF THE INVENTION

This invention relates to a lens driving device and, in particular, to an autofocus lens driving device for use in a portable compact camera.

The portable compact camera is mounted in a camera-equipped cellular mobile phone. The portable compact camera is provided with the autofocus lens driving device. Previously, various autofocus lens driving devices have been proposed (for example, see Japanese Unexamined Patent Application Publication No. 2008-122643 (JP-A 2008-122643) (which will be also called a first patent document)).

In general, the autofocus lens driving device comprises a tubular lens holder for holding a lens barrel including a plurality of lenses and a driving coil fixed around the lens holder. A magnetic field generating portion provided with a permanent magnet is disposed so as to be opposed to the driving coil. The magnetic field generating portion is fixed on a base. A combination of the lens barrel, the lens holder, and the driving coil serves as a movable portion of the lens driving device. On the other hand, a combination of the magnetic field generating portion and the base serves as a fixed portion of the lens driving device. In addition, the lens driving device comprises an elastic member mounted (or joined) to the lens holder (the movable portion) and the fixed portion. The elastic member supports the lens holder (the movable portion) in a direction of an optical axis shiftably so as to position the lens holder (the movable portion) in a radial direction. In the lens driving device having such a structure, the lens holder is positionally adjustable to the direction of the optical axis, by energizing the driving coil, according to an electromagnetic force due to interaction between a magnetic field of the permanent magnet and an electric current flowing through the driving coil. In this case, the movable portion makes a stop (or is positioned) at a position where the electromagnetic force balances with an urging force of the elastic member.

In a conventional lens driving device as is disclosed in the first patent document, the movable portion comprises the lens barrel, the lens holder, and the driving coil and the driving coil is mounted to an outer face of the lens holder. In other words, a plurality of lenses are contained in the interior of the lens barrel and the lens holder and the driving coil are disposed to the outside of the lens barrel. Accordingly, in the conventional lens driving device, the movable portion has a size (a radius) which is equal to a size obtained by summing up an internal radius of the lens barrel, a thickness of the lens barrel in a radial direction, a thickness of the lens holder in the radial direction, and a thickness of the driving coil in the radial direction. As a result, it is impossible to reduce the size of the movable portion. Accordingly, the conventional lens driving device is disadvantageous in that it is difficult to miniaturize the lens driving device.

### SUMMARY OF THE INVENTION

It is therefore an exemplary object of the present invention to provide a lens driving device which is capable of becoming smaller in size.

Other objects of this invention will become clear as the description proceeds.

On describing the gist of an exemplary aspect of this invention, it is possible to be understood that a lens driving device comprises a movable portion comprising a lens barrel including a plurality of lenses and a driving coil, a fixed portion comprising a magnetic field generating portion including a permanent magnet opposite to the driving coil, and an elastic member mounted to the movable portion and said fixed portion. The elastic member supports the movable portion in a direction of an optical axis shiftably so as to position the movable portion in a radial direction. The movable portion is positionally adjustable to the direction of the optical axis, by energizing said driving coil, according to an electromagnetic force due to interaction between a magnetic field of the permanent magnet and an electric current flowing through the driving coil. According to the exemplary aspect of this invention, the plurality of lenses are connected with the plurality of lenses fixed to each other. The lens holder holds only an uppermost one among the plurality of lenses while remaining ones in the plurality of lenses except for the uppermost one are put into an exposed state. The driving coil is disposed close to outer edges of the exposed lenses.

### BRIEF DESCRIPTION OF THE DRAWING

FIG. 1 is a schematic sectional view of an internal main portion of a related lens driving device;

FIG. 2 is a schematic sectional view of an internal main portion of a lens driving device according to a first exemplary embodiment of the present invention;

FIG. 3 is a schematic sectional view of an internal main portion of a lens driving device according to a second exemplary embodiment of the present invention; and

FIG. 4 is a schematic sectional view of an internal main portion of a lens driving device according to a third exemplary embodiment of the present invention.

### DESCRIPTION OF THE PREFERRED EMBODIMENTS

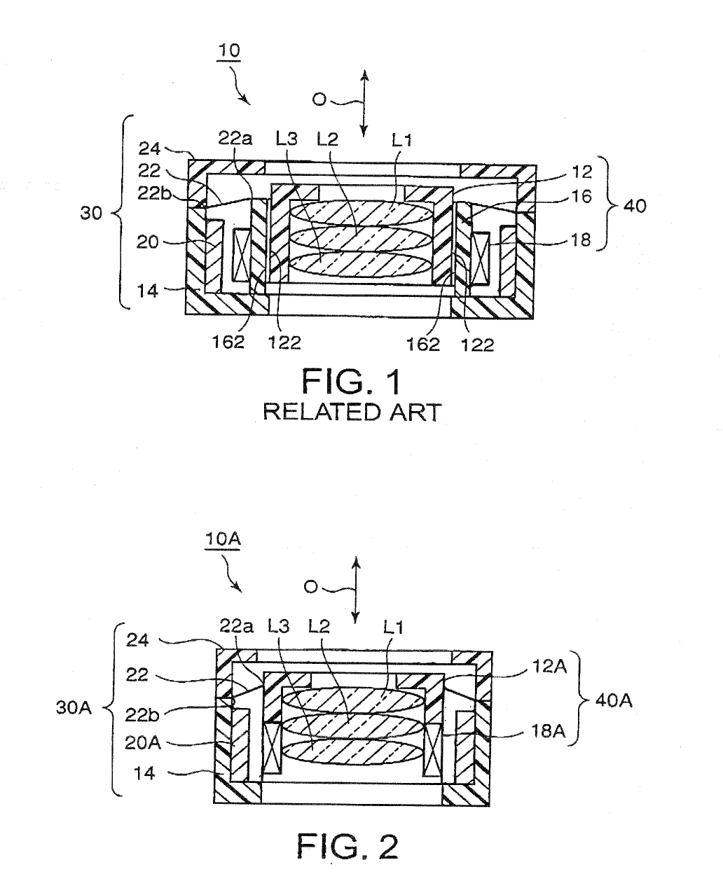

Referring to FIG. 1, a related lens driving device 10 will be described at first in order to facilitate an understanding of the present invention. FIG. 1 is a schematic sectional view of an internal main portion of the lens driving device 10. In the example being illustrated in FIG. 1, an up-and-down direction is a direction of an optical axis O of a lens.

However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10 is mounted to a camera-equipped cellular mobile phone which is enabled to perform automatic focusing. The lens driving device 10 is for moving a lens barrel 12 including first through third lenses L1, L2, and L3 in the direction of the optical axis O. The lens driving device 10 comprises an actuator base 14 which is disposed in a lower side in the direction of the optical axis O (the up-and-down direction). Although illustration is not made, the actuator base 14 has a lower portion on which an image pickup device disposed on a board is mounted. The image pickup device picks up a subject image formed by the lens barrel 12 to convert it into an electric signal. The image pickup device may, for example, comprise a CCD (charge coupled device) type image sensor, a CMOS (complementary metal oxide semiconductor) type image sensor, or the like. Accordingly, a camera module comprises a combination of the lens driving device 10, the board, and the image pickup device.

The lens driving device 10 comprises a tubular lens holder 16 for holding the lens barrel 12, a driving coil 18 fixed to the lens holder 16 so as to position around the lens holder 16, a fixed portion 30 which is fixed to the actuator base 14 and which comprises a magnetic field generating portion including a permanent magnet 20 opposite to the driving coil 18, an elastic member 22 mounted to the lens holder 16 and the fixed portion 30, and a cover 24. The elastic member 22 supports the lens holder 16 in the direction of the optical axis O shiftably so as to position the lens holder 16 in a radial direction. The magnetic field generating portion comprises a yoke (not shown).

The elastic member 22 has an inner end portion 22a mounted to the lens holder 16 and an outer end portion 22b mounted between the actuator base 14 of the fixed portion 30 and the cover 24.

A combination of the lens barrel 12, the lens holder 16, and the driving coil 18 serves as a movable portion 40 of the lens driving device 10. On the other hand, a combination of the magnetic field generating portion including the permanent magnet 20, the actuator base 14, and the cover 24 serves as the fixed portion 30 of the lens driving device 10.

The lens holder 16 has an inner wail 162 in which a female screw thread (not shown) is cut. On the other hand, the lens barrel 12 has an outer wall 122 in which a male screw thread (not shown) screwed in the above-mentioned female screw thread is cut. In a case of fitting the lens barrel 12 to the lens holder 16, it includes the steps of rotating the lens barrel 12 with respect to the lens holder 16 around the optical axis O to screw it along the direction of the optical axis O thereby accommodating the lens barrel 12 in the lens holder 16, and of connecting them to each other via an adhesive agent or the like.

In the lens driving device 10 having such a structure, by energizing the driving coil 18, it is possible to positionally adjust the lens holder 16 (the lens barrel 12) in the direction of the optical axis O according to an electromagnetic force due to interaction between a magnetic field of the permanent magnet 20 and an electric current flowing through the driving coil 18. In this event, the movable portion 40 makes a stop (or is positioned) at a position where the electromagnetic force balances with an urging force of the elastic member 22.

In the lens driving device 10 illustrated in FIG. 1, the movable portion 40 comprises the lens barrel 12, the lens holder 16, and the driving coil 18 and the driving coil 18 is mounted to an outer face of the lens holder 16. In other words, the first through the third lenses L1 to L3 are contained in the interior of the lens barrel 12 and the lens holder 16 and the driving coil 18 are disposed to the outside of the lens barrel 12. Accordingly, in the related lens driving device 10, the movable portion 40 has a size (a radius) which is equal to a size obtained by summing up an internal radius of the lens barrel 12, a thickness of the lens barrel 12 in a radial direction, a thickness of the lens holder 16 in the radial direction, and a thickness of the driving coil 18 in the radial direction. As a result, it is impossible to reduce the size of the movable portion 40. Accordingly, the related lens driving device 10 is disadvantageous in that it is difficult to miniaturize the lens driving device 10, as mentioned in the preamble of the instant specification.

Referring to FIG. 2, the description will proceed to a lens driving device 10A according to a first exemplary embodiment of this invention. FIG. 2 is a schematic sectional view of an internal main portion of the lens driving device 10A. In the example being illustrated in FIG. 2, an up-and-down direction is a direction of an optical axis O of a lens. However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10A is similar in structure and operation to the related lens driving device 10 except that the movable portion and the fixed portion are different from those illustrated in FIG. 1. The movable portion and the fixed portion are therefore depicted at 40A and 30A, respectively. The same reference symbols are attached to those having functions similar to those illustrated in FIG. 1, differences alone will be later described in order to simplify their explanation.

The illustrated movable portion 40A is similar in structure to the movable portion 40 illustrated in FIG. 1 except that the lens holder is deleted and the lens barrel and the driving coil are different from those illustrated in FIG. 1. The lens barrel and the driving coil are therefore depicted at 12A and 18A, respectively.

The first through the third lenses L1 to L3 are connected with the lenses L1 to L3 fixed to each other. Among the first through the third lenses L1 to L3, the first lens L1 is an uppermost lens.

Different from the lens barrel 12 illustrated in FIG. 1, the lens barrel 12A holds only the first lens (the uppermost lens) L1. Accordingly, remaining ones in the first through the third lenses L1 to L3 except for the uppermost lens L1, namely, the second and the third lenses L2 and L3 are put into an exposed state.

Furthermore, the driving coil 18A is disposed close to outer edges of the exposed second and third lenses L2 and L3. In the example being illustrated, the driving coil 18A is disposed so as to directly make contact with the outer edges of the exposed second and third lenses L2 and L3. Inasmuch as the driving coil 18A is disposed close to the outer edges of the exposed second and third lenses L2 and L3 in the manner described above, the driving coil 18A has an external diameter which is smaller than that of the driving coil 18 illustrated in FIG. 1.

Therefore, the movable portion 40A has a size (a radius) which is equal to a size obtained by adding up an internal radius of the lens barrel 12A and a thickness of the driving coil 18A in a radial direction alone. Inasmuch as it is possible to delete spaces of the lens barrel 12A and the lens holder in the manner which is described above, it is possible to reduce the size of the movable portion 40A.

Inasmuch as the movable portion 40A comprises no lens holder, the inner end portion 22a of the elastic member 22 is mounted to the lens barrel 12A.

The illustrated fixed portion 30A is similar in structure to the fixed portion 30 illustrated in FIG. 1 except that the permanent magnet is modified from that illustrated in FIG. 1 as will later become clear. The permanent magnet is therefore depicted at 20A.

The permanent magnet 20A is disposed opposite to the driving coil 18A. Therefore, the permanent magnet 20A has an external diameter which is smaller than that of the permanent magnet 20 illustrated in FIG. 1.

Inasmuch as it is possible to reduce the size of the movable portion 40A in the manner which is described above, it results in becoming the lens driving device 10A smaller in size.

Although the driving coil 18A is disposed so as to directly make contact with the outer edges of the exposed second and third lenses L2 and L3 in the lens driving device 10A illustrated in FIG. 2, the driving coil 18A may be disposed with an air layer sandwiched between the driving coil 18A and the outer edges of the exposed second and third lenses L2 and L3.

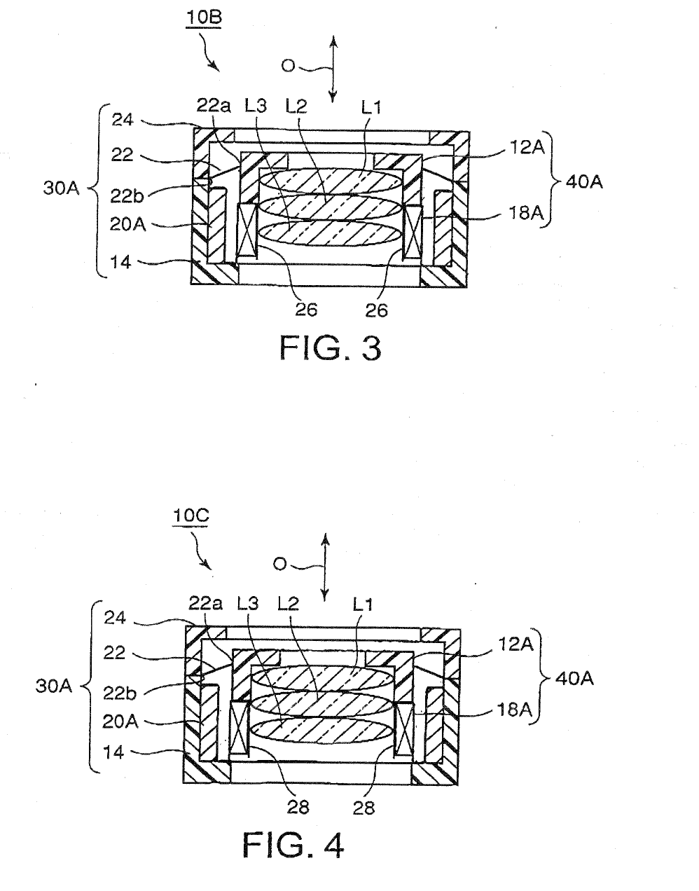

Referring to FIG. 3, the description will proceed to a lens driving device 10B according to a second exemplary embodiment of this invention. FIG. 3 is a schematic sectional view of an internal main portion of the lens driving device 10B. In the example being illustrated in FIG. 3, an up-and-down direction is a direction of an optical axis O of a lens. However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10B is similar in structure and operation to the lens driving device 10A illustrated in FIG. 2 except that the lens driving device 10B further comprises a cylindrical shading film 26. The same reference symbols are attached to those having functions similar to those illustrated in FIG. 2, differences alone will be later described in order to simplify their explanation.

The shading film 26 is disposed between the exposed second and third lenses L2 and L3 and the driving coil 18A. The illustrated shading film 26 has a thickness between 10 μm and 300 μm, both inclusive.

Inasmuch as the shading film 26 is disposed to the outer portion of the exposed second and third lenses L2 and L3 in the manner which is described above, it is possible to improve shading of the first through the third lenses L1 to L3.

Referring to FIG. 4, the description will proceed to a lens driving device 10C according to a third exemplary embodiment of this invention. FIG. 4 is a schematic sectional view of an internal main portion of the lens driving device 10C. In the example being illustrated in FIG. 4, an up-and-down direction is a direction of an optical axis O of a lens. However, in an actual use situation, the direction of the optical axis O, namely, the up-and-down direction becomes a fore-and-aft direction. In other words, an upper direction becomes a front direction while a lower direction becomes a rear direction.

The illustrated lens driving device 10C is similar in structure and operation to the lens driving device 10A illustrated in FIG. 2 except that the lens driving device 10C further comprises a cylindrical thermal insulation film 28. The same reference symbols are attached to those having functions similar to those illustrated in FIG. 2, differences alone will be later described in order to simplify their explanation.

The thermal insulation film 28 is disposed between the exposed second and third lenses L2 and L3 and the driving coil 18A. The illustrated thermal insulation film 28 has a thickness between 10 μm and 300 μm, both inclusive.

Inasmuch as the thermal insulation film 28 is disposed to the outer portion of the exposed second and third lenses L2 and L3 in the manner which is described above, it is possible to be hard to convey heat (e.g. heat generated on flowing the electric current through the driving coil 18A or the like) to the first through the third lenses L1 to L3 from the outside and it results in effect of thermal insulation.

In the lens driving device according to the exemplary aspect of this invention, the elastic member may have an inner end portion mounted to the lens barrel.

According to the lens driving device of a first exemplary aspect of this invention, the driving coil is disposed so as to directly make contact with the outer edges of the exposed lenses.

According to the lens driving device of a second exemplary aspect of this invention, the lens driving device further comprises a cylindrical shading film disposed between the exposed lenses and the driving coil. The shading film may have a thickness between 10 μm and 300 μm, both inclusive.

According to the lens driving device of a third exemplary aspect of this invention, the lens driving device further comprises a cylindrical thermal insulation film disposed between the exposed lenses and the driving coil. The thermal insulation film may have a thickness between 10 μm and 300 μm, both inclusive.

An exemplary advantage according to the invention is that it is possible to become the lens driving device smaller in size. This is because the plurality of lenses are connected with the plurality of lenses fixed to each other, the lens holder holds only an uppermost one among the plurality of lenses, remaining ones in the plurality of lenses except for the uppermost one are put into an exposed state, and the driving coil is disposed close to outer edges of the exposed lenses.

While this invention has been particularly shown and described with reference to the exemplary embodiments thereof, the invention is not limited to the embodiments. It will be understood by those of ordinary skill in the art that various changes in form and details may be therein without departing from the spirit and scope of the present invention as defined by the claims.

What is claimed is:

1. A lens driving device comprising:
a movable portion comprising a lens barrel including a plurality of lenses and a driving coil;
a fixed portion comprising a magnetic field generating portion including a permanent magnet opposite to said driving coil; and
an elastic member mounted to said movable portion and said fixed portion, said elastic member supporting said movable portion in a direction of an optical axis shiftably so as to position said movable portion in a radial direction, whereby said movable portion is positionally adjustable to the direction of the optical axis, by energizing said driving coil, according to an electromagnetic force due to interaction between a magnetic field of said permanent magnet and an electric current flowing through said driving coil,
wherein said plurality of lenses are connected with said plurality of lenses fixed to each other,
wherein said lens holder holds only an uppermost one among said plurality of lenses, remaining ones in said plurality of lenses except for said uppermost one are put into an exposed state,
wherein said driving coil is disposed close to outer edges of said exposed lenses.

2. The lens driving device as claimed in claim 1, wherein said elastic member has an inner end portion mounted to said lens barrel.

3. The lens driving device as claimed in claim 1, wherein said driving coil is disposed so as to directly make contact with the outer edges of said exposed lenses.

4. The lens driving device as claimed in claim 1, wherein further comprises a cylindrical shading film disposed between said exposed lenses and said driving coil.

5. The lens driving device as claimed in claim 4, wherein said shading film has a thickness between 10 μm and 300 μm, both inclusive.

6. The lens driving device as claimed in claim 1, wherein further comprises a cylindrical thermal insulation film disposed between said exposed lenses and said driving coil.

7. The lens driving device as claimed in claim 6, wherein said thermal insulation film has a thickness between 10 μm and 300 μm, both inclusive.
